(19) United States
(12) Patent Application Publication
(10) Pub. No.: US 2008/0037073 A1
(43) Pub. Date: Feb. 14, 2008

(54) Image processor and image processing method

(75) Inventor: Hideomi Fujimoto, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 11/783,945

(22) Filed: Apr. 13, 2007

(30) Foreign Application Priority Data
Apr. 27, 2006 (JP) 2006-123888

(51) Int. Cl. H04N 1/40

(52) U.S. Cl. 358/471

(57) ABSTRACT

In an image processor, a Joint Photographic Experts Group (JPEG) decoder decodes JPEG-compressed image data and stores the image data in a first Static Random Access Memory (SRAM). A Modified Modified Read (MMR) decoder decodes MMR-compressed separation data and stores the separation data in a second SRAM. A multivaluing unit performs multivalue processing on the separation data such that the total length of the separation data and the image data are 32 bits for each pixel. An image synthesizer synthesizes the separation data and the image data multivalued for each pixel into data with a length of 32 bits.

### CROSS-REFERENCE TO RELATED APPLICATIONS

The present document incorporates by reference the entire contents of Japanese priority documents, 2006-123888 filed in Japan on Apr. 27, 2006.

### BACKGROUND OF THE INVENTION

1. Field of the Invention

The present invention relates to an image processor and an image processing method.

2. Description of the Related Art

Upon printing of an image including a text image that requires a clear representation of black color and a photographic image that requires a fine expression of intermediate tones, a commonly used image processor performs image processing that emphasizes either text image or photographic image and outputs a resulting image. However, when images are mixed that include different characteristics such as a text and a photograph, an appropriate image processing on one of the images results in a deterioration of image quality of the other image.

Japanese Patent Application Laid-open No. 2001-211329 discloses a technology in which image data and separation data that represents characteristics of the image data are stored in separate memories. The image data and the separation data are read for each pixel. Based on the read separation data, image processing is performed on the read image data for each pixel. The image data subjected to image processing is written to each pixel.

However, in the conventional technology, upon image processing of one pixel, reading of the image data, reading of the separation data, and writing of the image data after image processing are performed for each pixel, and the memories need to be accessed three times per pixel. Thus, there is a need for a high-speed image processing that reduces resource consumption necessary for memory access.

### SUMMARY OF THE INVENTION

It is an object of the present invention to at least partially solve the problems in the conventional technology.

An image processor includes a first decoding unit that decodes compressed image data, a second decoding unit that receives separation data in a compressed format that indicates a characteristic of an image, and decodes the separation data, and a synthesizing unit that synthesizes decoded image data and decoded separation data for each pixel into data with a length of an integral multiple of 32 bits.

An image processing method that is applied to an image processor, includes first-decoding compressed image data, receiving separation data in a compressed format that indicates a characteristic of an image, second-decoding the separation data, and synthesizing decoded image data and decoded separation data for each pixel into data with a length of an integral multiple of 32 bits.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an image processor according to a first embodiment of the present invention;

FIG. 2 is a schematic for explaining image data that is decoded by a JPEG decoder shown in FIG. 1;

FIG. 3 is a schematic of an example of synthesized data obtained by synthesis of separation data and the image data performed by an image synthesizer shown in FIG. 1;

FIG. 4 is a functional block diagram of an image-processing unit shown in FIG. 1;

FIG. 5 is a flowchart of image processing according to the first embodiment;

FIG. 6 is a flowchart of image processing according to the first embodiment;

FIG. 7 is a schematic for explaining blocking of the separation data and one-dimensional compression of the separation data;

FIG. 8 is a functional block diagram of a commonly used image processor;

FIG. 9 is functional block diagram of an image processor that includes a CPU instead of an image processing block shown in FIG. 8;

FIG. 10 is a functional block diagram of the image processor according to a second embodiment of the present invention;

FIG. 11 is a flowchart of image processing according to the second embodiment; and

FIG. 12 is a functional block diagram of an image forming apparatus according to a third embodiment of the present invention.

### DETAILED DESCRIPTION OF THE PREFERRED EMBODIMENTS

Exemplary embodiments of the present invention are explained in detail below with reference to the accompanying drawings.

In an image processor according to a first embodiment of the present invention, a Joint Photographic Experts Group (JPEG) decoder decodes compressed image data and stores the image data. A Modified Modified Read (MMR) decoder receives separation data that is an image feature quantity in a compressed format, decodes the separation data and stores the separation data. A multivaluing unit performs multivalue processing on the separation data such that a total data length of the decoded separation data and the decoded image data becomes 32 bits for each pixel. An image synthesizer performs synthesis such that the multivalued separation data and image data become equal to the data length of 32 bits for each pixel.

A decoding unit, which decodes the image data and the separation data, performs synthesis such that the data length of a resulting data becomes 32 bits. Due to this, an image-processing unit that performs image processing on the image data, a Central Processing Unit (CPU), and an output unit that outputs an image can access and perform image processing on the data of 32-bit length that is a process unit. Thus, a high-speed memory access and a high-speed image processing are enabled. Further, when carrying out image processing, 32-bit synthesized data is read only once and based on the read separation data, the image data can be processed. Thus, a necessity to read-access the separation data from pixel data is removed, thereby reducing memory access and enabling a high-speed image processing.

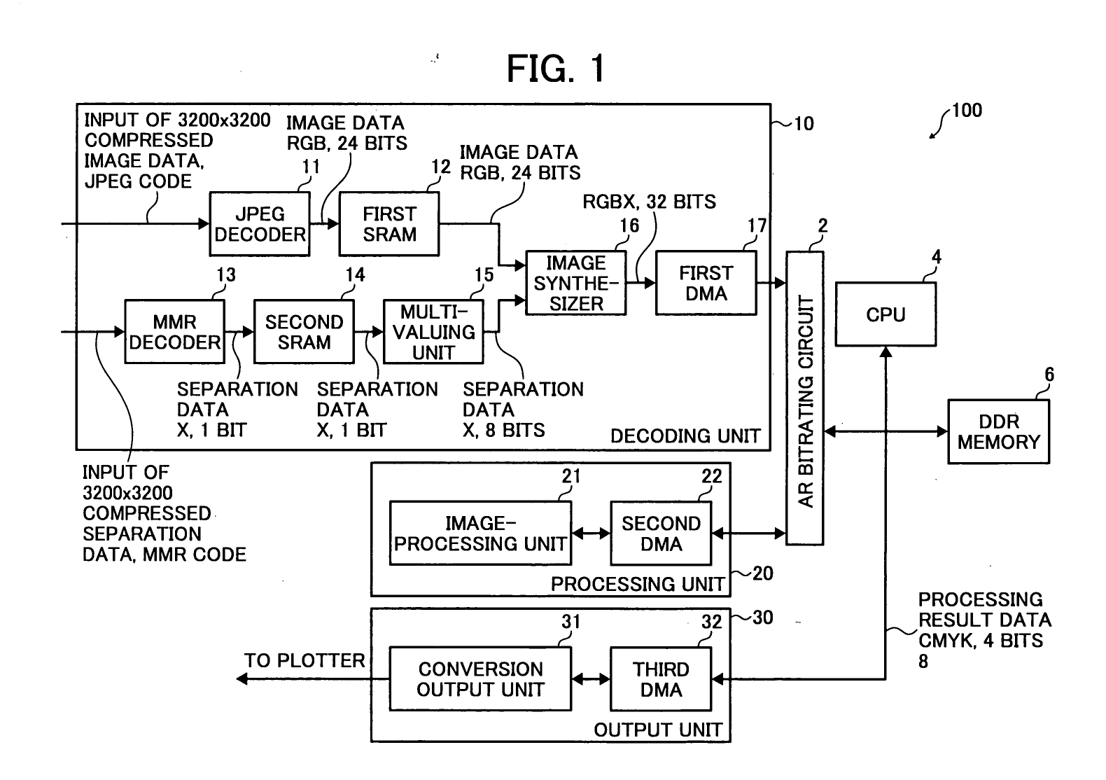

FIG. 1 is a functional block diagram of the image processor according to the first embodiment. An image processor 100 according to the first embodiment includes a decoding unit 10, a processing unit 20, an output unit 30, an arbitrating circuit 2, a CPU 4, a Double Data Rate (DDR) memory 6, and a bus 8.

The decoding unit 10 includes a JPEG decoder 11, a first Static Random Access Memory (SRAM) 12, an MMR decoder 13, a second SRAM 14, a multivaluing unit 15, an image synthesizer 16, and a first Direct Memory Access (DMA) 17. The processing unit 20 includes an image-processing unit 21 and a second DMA 22. The output unit 30 includes a conversion output unit 31 and a third DMA 32.

JPEG-compressed image data and MMR-compressed separation data are input to the decoding unit 10. The JPEG-compressed image data in the first embodiment is a JPEG-compressed Red Green and Blue (RGB) (8 bits per RGB) image of 3200×3200 pixels.

In the first embodiment, a separation image of 3200×3200 pixels corresponding to the image data is MMR compressed according to block units of JPEG color compression into block units of 16×16 pixels to get the separation data. A value of each pixel of the separation data is fixed as “1” if the corresponding pixel of the image data is determined as a text image portion. A value of each pixel of the separation data is fixed as “0” if the corresponding pixel of the image data is determined as a non-text image portion. The separation data includes one bit for one pixel. Hereinafter, the separation data is indicated by X.

In the image processor 100, the decoding unit 10 inputs the encoded data mentioned earlier and performs decoding. The processing unit 20 performs image processing on the image data decoded by the decoding unit 10. The output unit 30 outputs a result of image processing by the processing unit 20 to a plotter.

Each of the decoding unit 10, the processing unit 20, and the output unit 30 includes a DMA having a 32-bit data buswidth. The decoding unit 10, the processing unit 20, and the output unit 30 perform data transfer with the DDR memory 6 via the bus 8 such as a Peripheral Component Interconnect (PCI) Express bus. A crossbar switch (not shown) can also be included as a device that selects a path between the CPU 4 and the DDR memory 6.

The arbitrating circuit 2 selects paths that are used by the decoding unit 10 and the processing unit 20 to access the DDR memory 6. For example, the PCI-Express bus, which forms the bus 8 is connected to the CPU 4, the arbitrating circuit 2, the output unit 30, and the DDR memory 6 and enables extremely high-speed data transfer.

JPEG-encoded data and MMR-encoded data, which are input to the image processor 100, are input to the JPEG decoder 11 and the MMR decoder 13 respectively. The JPEG decoder 11 decodes 24-bit RGB (8 bits per color component) image data and outputs the image data. The MMR decoder 13 decodes and outputs the one-bit-per-pixel separation data.

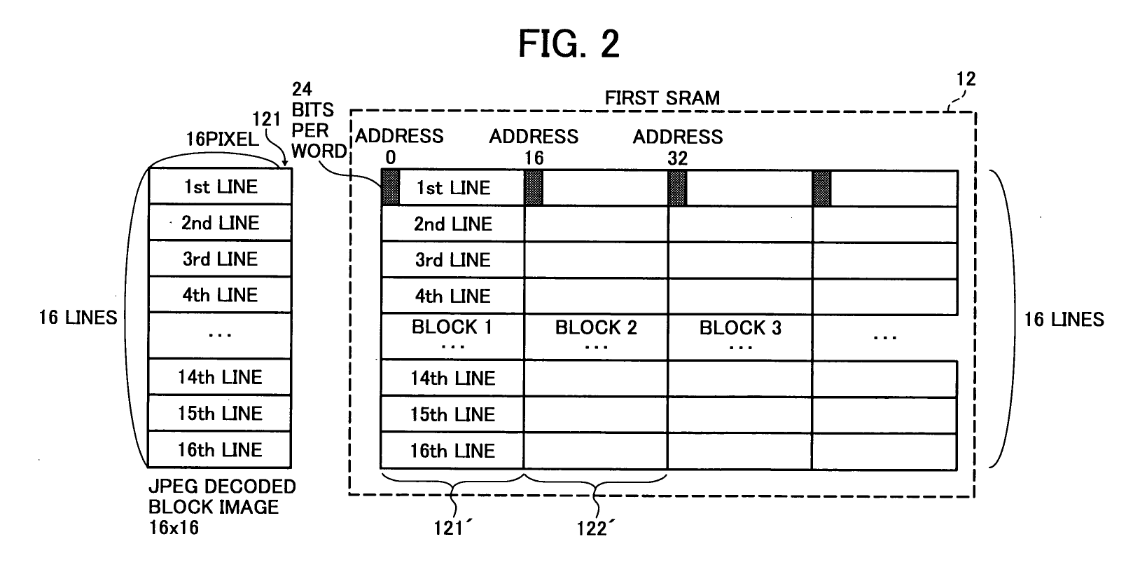

FIG. 2 is a schematic for explaining the image data that is decoded by the JPEG decoder 11. Image data 121, which is decoded by the JPEG decoder 11, is stored in the first SRAM 12. The first SRAM 12 includes sixteen SRAM of 3200 pixel lines of 24-bit per word.

Data of one pixel of 24-bit RGB is stored in one word. Based on a JPEG standard, because color JPEG is encoded into block units of 16 by 16, in other words, 16×16 pixels, the JPEG decoder 11 also outputs the image data in the block units of 16×16 pixels of 24-bit per RGB pixel. Sixteen pixels of the first line in the first block are stored in addresses 0 to 15 of the first line of the first SRAM 12. Sixteen pixels of the second line are stored in addresses 0 to 15 of the second line of the first SRAM 12. Sixteen pixels of the third line are stored in addresses 0 to 15 of the third line of the first SRAM 12. Thus, sixteen pixels and sixteen lines of blocks (numeral 121 shown in FIG. 2) are distributed and stored in sixteen lines of the first SRAM 12 (numeral 121′ shown in FIG. 2).

Similarly, subsequent blocks are stored in addresses 16 to 31 (122′ in FIG. 2) of each of the sixteen lines of the first SRAM 12. The operation mentioned earlier is repeated to store 3200×16 lines in the first SRAM 12, and process performed by the JPEG decoder 11 is terminated.

Similarly, because the separation data is encoded in the block units of 16×16 pixels, the MMR decoder 13 also outputs the separation data in the block units of 16×16 pixels of one bit per pixel. The separation data that is expanded (decoded) by the MMR decoder 13 is stored in the second SRAM 14. The second SRAM 14 includes sixteen SRAM of 400 pixel lines of 8-bit per word. Eight pixels of one bit of the separation data are stored in one word. Due to this, sixteen pixels of the first line in the first block of the separation data are stored in addresses 0 to 1 of the first line of the second SRAM 14. Sixteen pixels of the second line are stored in addresses 0 to 1 of the second line of the second SRAM 14. Sixteen pixels of the third line are stored in addresses 0 to 1 of the third line of the second SRAM 14. Thus, sixteen lines of sixteen pixels of the blocks are distributed and stored in the sixteen lines of the second SRAM 14.

Similarly, subsequent blocks are stored in addresses 2 to 3 of each of the sixteen lines of the second SRAM 14. The operation mentioned earlier is repeated to store 400×16 lines in the second SRAM 14, and process performed by the MMR decoder 13 is terminated.

Upon completion of storage of data of sixteen lines in the first SRAM 12 and the second SRAM 14, the image data of one bit of the separation data is output from the second SRAM 14 and the multivaluing unit 15 performs multivalue processing on the output separation data to convert one bit to 8 bits. A method which shifts one bit of the separation data to a bit position higher by 7 bits such as shifting “1” to “10000000” or shifting “0” to “00000000” can be used as a multivaluing method.

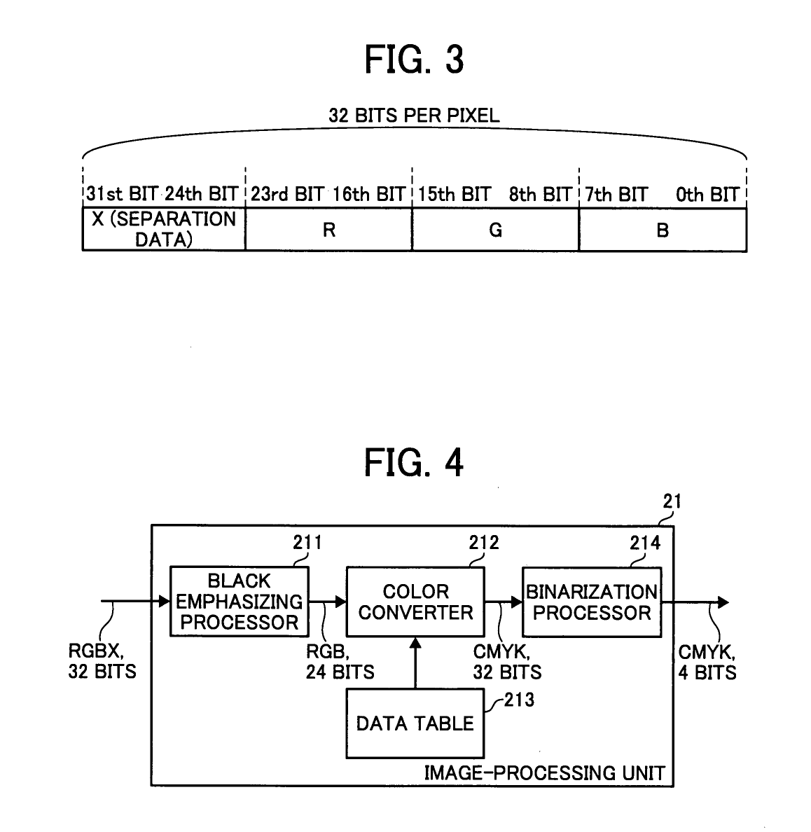

FIG. 3 is a schematic of an example of the synthesized data due to synthesis of the separation data and the image data by the image synthesizer 16. The image synthesizer 16 synchronously inputs in one-pixel units, 8-bit multivalued separation data and 24-bit RGB image data that is stored in the first SRAM 12. Next, the image synthesizer 16 synthesizes the image data and the separation data to generate composite image data (32-bit-per-pixel RGBX data (X denotes the separation data)). Next, using access by the first DMA 17, the image synthesizer 16 writes the composite image data in 32-bit RGBX data units to the DDR memory 6 via the arbitrating circuit 2 and the bus 8. The process mentioned earlier is performed until completion of output of the entire data stored in the first SRAM 12 and the second SRAM 14. Due to this, the composite image data of 3200×16 pixels is expanded on the DDR memory 6.

Next, using the second DMA 22, the processing unit 20 reads, in 32-bit RGBX data units, the composite image data of 3200×16 pixels on the DDR memory 6, and inputs the read composite image data. The processing unit 20 can input and process the composite image data in 32-bit-per-pixel RGBX units.

FIG. 4 is a functional block diagram of the image-processing unit 21. The image-processing unit 21 includes a black emphasizing processor 211, a color converter 212, a data table 213, and a binarization processor 214. When inputting RGBX (32-bit) and outputting RGB data (24-bit), the black emphasizing processor 211 enables the image-processing unit 21 to output a black text as a distinct black text. For example, upon determining that X in RGBX (32-bit) is not “00000000”, in other words, based on a predetermined regulation, upon determining that the pixel point is a text area and that each of 8 bits (0 to 255) of R, G, and B are less than or equal to “64”, in other words, nearly black, the black emphasizing processor 211 sets each of 8 bits of R, B, and G to “0”. Due to this, a text pixel, which includes the image data that is nearly black, can be converted to only black RGB (24-bit) that emphasizes black color of the text image.

The color converter 212 generates Cyan Magenta Yellow Key (CMYK) (8 bits per color component, total 32 bits) data from RGB (8 bits per color component, total 24 bits). In a conversion method, based on the prior formulated data table 213, CMYK (8 bits per color component, total 32 bits) are uniquely determined from data values of RGB (24 bits) and converted. However, the conversion method is explained merely as an example.

The binarization processor 214 performs binarization using a simple threshold value such that each of 8 bits (0 to 255) of C, M, Y, and K in CMYK (32 bits) are set as “1” if the bits are greater than or equal to 128 bits, and are set as “0” if the bits are not greater than or equal to 128 bits.

Due to the process mentioned earlier, CMYK (1 bit per color component, data of total 4 bits) that is output from the processing unit 20 is again written to the DDR memory 6 by the second DMA 22 and a processing result of the processing unit 20 is returned to the DDR memory 6. Because the second DMA 22 accesses the DDR memory 6 in 32-bit units, CMYK (4 bits) is written to the DDR memory 6 in 8-pixel units. However, the drawback can be overcome by including a buffer of 32 bits inside the second DMA 22.

After repeating processes performed by the decoding unit 10 and the processing unit 20 and completing storage in the DDR memory 6 of an image processing result by CMYK (1 bit per color component, data of total 4 bits) of one page, the third DMA 32 transfers the image processing result to the conversion output unit 31 and outputs the image processing result to the plotter.

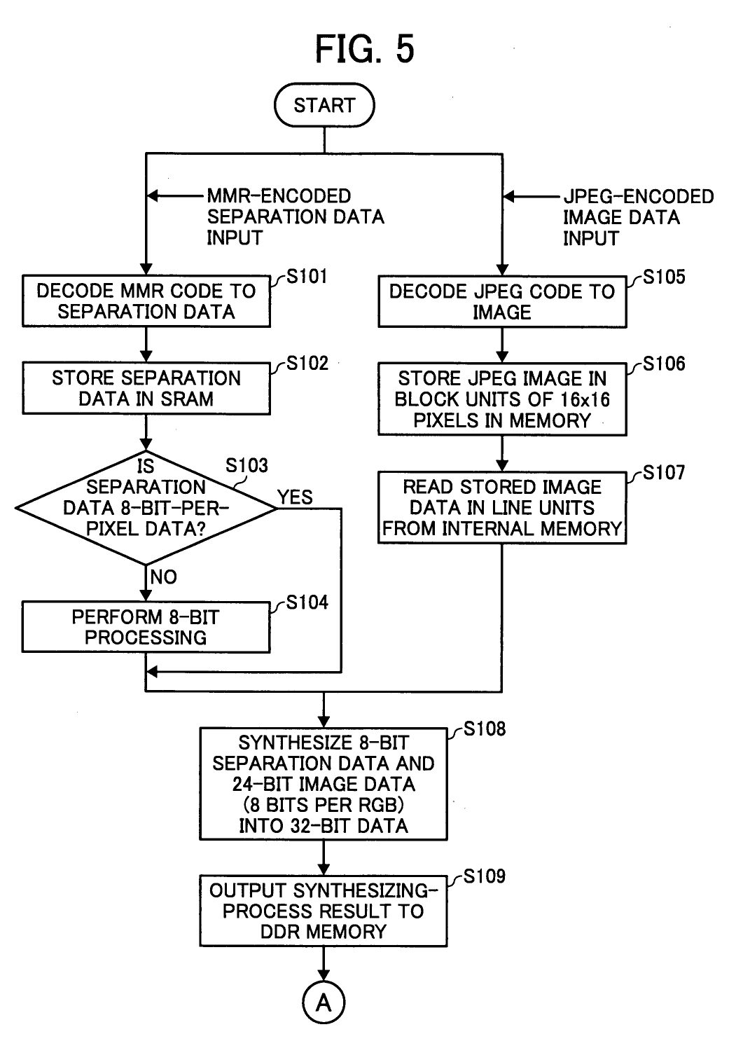

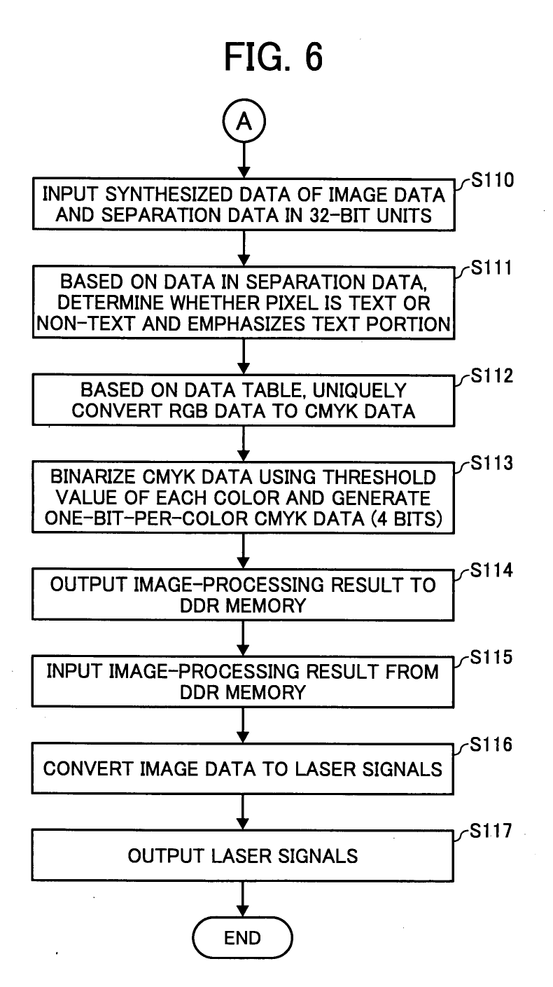

FIGS. 5 and 6 are flowcharts of image processing according to the first embodiment. Upon inputting MMR encoded separation data, the MMR decoder 13 performs MMR decoding (step S101) and stores the separation data in the second SRAM 14 (step S102). The multivaluing unit 15 determines whether the separation data is 8-bit-per-pixel data (step S103). If the separation data is not 8-bit-per-pixel data (No at step S103), the multivaluing unit 15 performs 8-bit processing (step S104).

The JPEG decoder 11 inputs JPEG-encoded image data, and decodes a JPEG code to the image (step S105), and stores the JPEG image in block units of 16×16 pixels in the first SRAM 12 (step S106). The first DMA 17 reads the stored image data from the first SRAM 12 in line units and transmits the read image data to the image synthesizer 16 (step S107).

The image synthesizer 16 performs synthesis on the 24-bit image data input from the first SRAM 12 and the 8-bit separation data subjected to multivalue processing (step S108). The first DMA 17 outputs, to the DDR memory 6 via the arbitrating circuit 2, the data subjected to synthesis (step S109). The process mentioned earlier is performed in the decoding unit 10 (FIG. 5).

The second DMA 22 of the processing unit 20 reads the data obtained by synthesizing the image data and the separation data in 32-bit units from the DDR memory 6 (step S110), and outputs the read data to the image-processing unit 21. Based on data included in the separation data, the black emphasizing processor 211 determines whether a pixel is text or non-text, and emphasizes the pixel of text portion (step S111). Based on the data table 213, the color converter 212 uniquely converts RGB data to 32-bit CMYK data (step S112).

The binarization processor 214 performs binarization of each color of the 32-bit CMYK data, and generates 1-bit-per-color CMYK data (total: 4 bits) based on the threshold value (step S113). The second DMA 22 outputs, to the DDR memory 6, the image processing result subjected to 4-bit processing (step S114). The process mentioned earlier is performed in the processing unit 20.

The third DMA 32 of the output unit 30 reads from the DDR memory 6, data of the image processing result that is generated at step S114 and transmits the read data to the conversion output unit 31 (step S115). The conversion output unit 31 converts the image data to laser signals and outputs the laser signals to the not shown plotter (step S116). The not shown plotter outputs the received laser signals to form the image (step S117). The process mentioned earlier is performed in the output unit 30 (FIG. 6).

Lossy compressed data other than JPEG can also be used as the image data. Human beings find it difficult to recognize a high frequency in the image. Thus, using lossy compressed data enables to realize a higher compression ratio and overcome sensory characteristics of human beings such as imperceptiveness to color difference.

Using losslessly compressed data as the separation data is desirable. Because the separation data is used by the processing unit 20 as data representing the image feature quantity, deterioration of the separation data due to compression needs to be avoided. In lossless compression, because the separation data is compressed while completely storing data included in the separation data, decoding of accurate data is enabled.

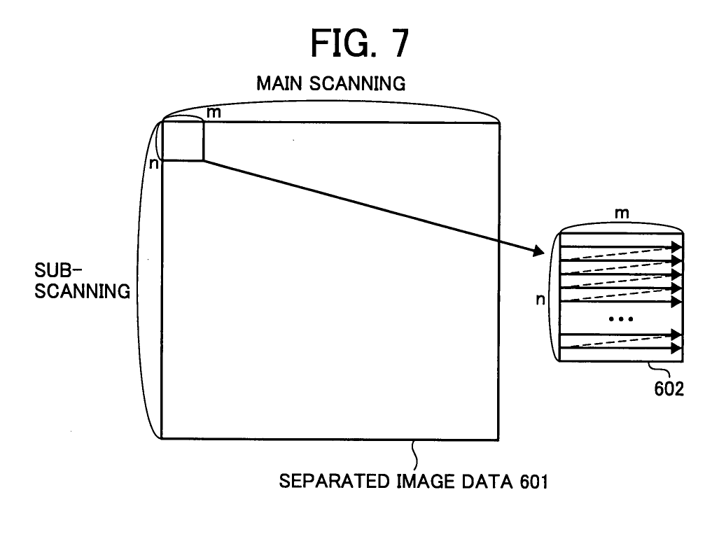

FIG. 7 is a schematic for explaining blocking to one-dimensionally compress the separation data. The separation data is desirably compressed into a block size of m×n that is a compressed block unit of the image data.

When compressing the image data into the block units, JPEG color image data is often compressed into block units of 16×16 pixels. Further, JPEG monochrome image data is often compressed into block units of 8×8 pixels.

If the separated image data (601 in FIG. 7) corresponding to compression of the block units is also compressed according to a compression method of the image data into block units of 16×16 pixels for color image data or block units of 8×8 pixels for monochromatic image data, when synthesizing the separation data and the image data after decoding, a correspondence of the respective pixels can be easily established. Further, as indicated by the numeral 602 shown in FIG. 7, if the separation data itself is subjected to a one-dimensional compression method, the block size of m×n can be freely controlled according to the compressed block units of the image data.

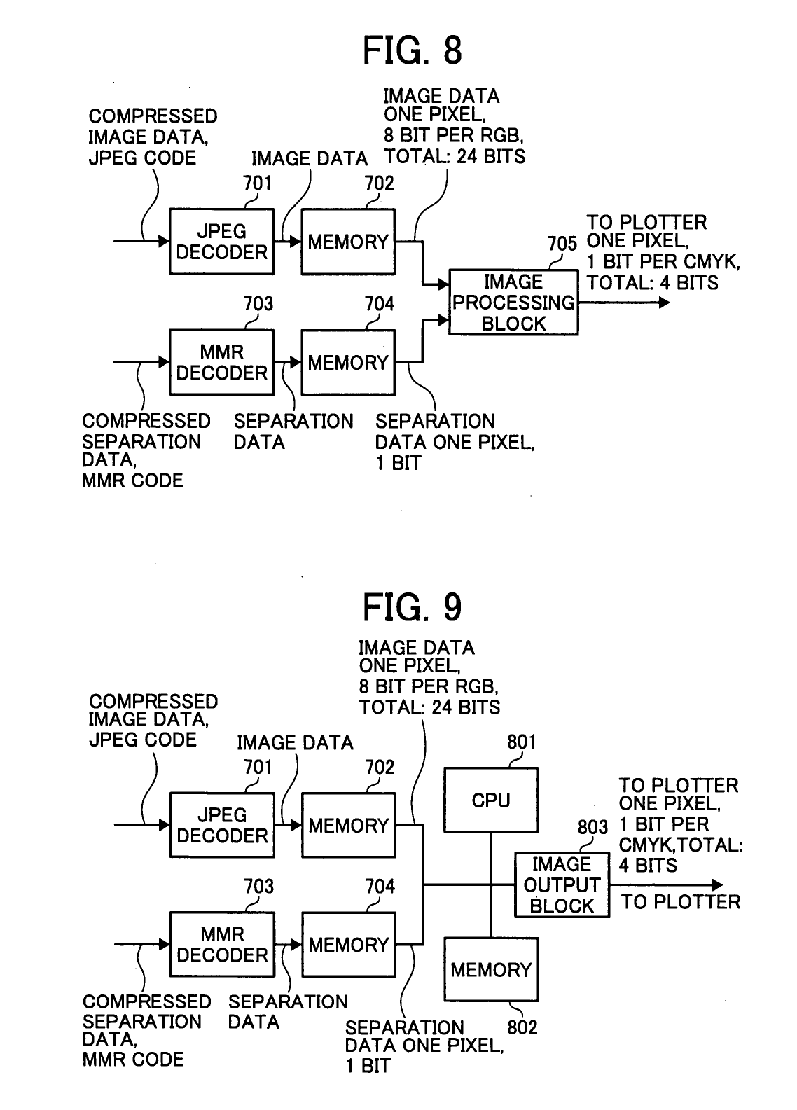

FIG. 8 is a functional block diagram of a commonly used image processor. The image processor 100 according to the first embodiment is compared to the commonly used image processor. For example, in the commonly used image processor, it is assumed that a scanner image is split into the image data and the separation data and the image data and the separation data are stored in a storage device such as a Hard Disk Drive (HDD). It is further assumed that the image data is JPEG compressed and the separation data is MMR binary compressed for reducing data size. In a structure shown in FIG. 8, the compressed JPEG code is input to a JPEG decoder 701 that decodes the image data, and the image data subjected to decoding is loaded into a memory 702. Each pixel of the image data includes R (8-bit), G (8-bit), and B (8-bit) data.

The MMR-encoded data is input to an MMR decoder 703 that decodes the separation data, and the separation data subjected to decoding is loaded into a memory 704. Each pixel of the separation data is one bit. Subsequently, an image processing block 705 synchronously inputs the image data (RGB=24 bits) and the separation data (1 bit) stored in pixel units, respectively, to the memory 702 and the memory 704. Further, the image processing block 705 refers to a separation data pixel (1 bit) and performs image processing on an image data pixel (RGB=24). Subsequently, the image processing block 705 outputs an output result as binarized CMYK data to a not shown plotter.

FIG. 9 is a functional block diagram of an image processor that includes a CPU 801 instead of the image processing block 705. The CPU 801 reads in word units (32-bit), data from the memory 702 and the memory 704, and writes an output to a memory 802.

In the commonly used image processor having the structure shown in FIG. 9, when carrying out image processing in one-pixel unit, the CPU 801 reads the image data pixel (RGB=24 bits) from the memory 702 and reads the separation data (1-bit) from the memory 704. The CPU 801 writes to the memory 802, the image data (CMYK=4 bits) of the image processing result. An image output block 803 reads from the memory 802, the image data (CMYK=4 bits) of the image processing result and outputs the read image data to the not shown plotter. When inputting the image data and the separation data of one pixel and outputting the image of the image processing result of one pixel, the CPU 801 needs to access the memories three times. For example, even upon assuming that the memory 702, the memory 704, and the memory 802 are physically the same memory, accessing three different addresses on the memory similarly necessitates frequent memory access.

However, compared to the commonly used image processor, in the image processor 100 according to the first embodiment, the image data and the separation data are synthesized in pixel units to the data length of one word and are memory-output to read the synthesized data and to retrieve the separation data and the image data. Thus, the CPU 4 can access the memory more effectively and perform image processing.

Further, apart from the CPU 4 according to the first embodiment, the processing unit 20 that reads the memory in word units (32-bit) can similarly access the memory effectively and perform image processing.

In other words, in the image processor 100 according to the first embodiment, the processing unit 20, the CPU 4, and the output unit 30 that perform various processes on the image data can access and perform image processing on data having the data length of 32 bits that is a process unit. Due to this, a high-speed memory access and a high-speed image processing are enabled. Further, when carrying out image processing, the synthesized data subjected to 32-bit processing is read only once and based on the read separation data the image processor 100 can perform image processing on the image data. Thus, compared to image processing in which the separation data and the image data are read for each pixel, the frequency of memory access can be reduced and a high-speed image processing can be performed.

In the first embodiment, the processing unit 20 is formed as having a hardware structure using a chip. However, the processing unit 20 can also be formed by using the commonly used 32-bit CPU 4 as a first modification. In the first modification, similarly as the processing unit 20, the CPU 4 also accesses the memory and performs image processing in 32-bit units. Thus, image processing can be performed without reducing the access efficiency.

In the first embodiment, the DMA, the memory, and the CPU 4 are formed as a 32-bit processor. However, the DMA, the memory, and the CPU 4 can also be formed as a 64-bit processor in a second modification. The 64-bit processor is highly viable as one of integral multiple processors of 32 bits.

In the second modification, a total of 63 bits that include 21 bits each of RGB and 1 bit of the separation data are synthesized without performing multivalue processing to obtain 64-bit synthesized data.

Or in a total of 60 bits that include 20 bits each of RGB and 1 bit of the separation data, the separation data can be changed to 4 bits through multivalue processing and synthesized to obtain 64-bit synthesized data. Similarly, 4 bits of image feature quantity data can be used originally, and the synthesized data can be used as 64-bit synthesized data.

In a second embodiment of the present invention, the image data and the separation data subjected to decoding are not stored in the memories unlike in the first embodiment. The separation data is subjected to multivalue processing such that the synthesized data becomes 32 bits and the image data and the separation data are synthesized in each pixel to get 32-bit length. Due to this, the memories that store the decoded image data and the decoded separation data can be omitted. Further, because access to the decoded image data and the decoded separation data is omitted, the scale of the image processor can be simplified and a high-speed image processing with reduced memory access is enabled.

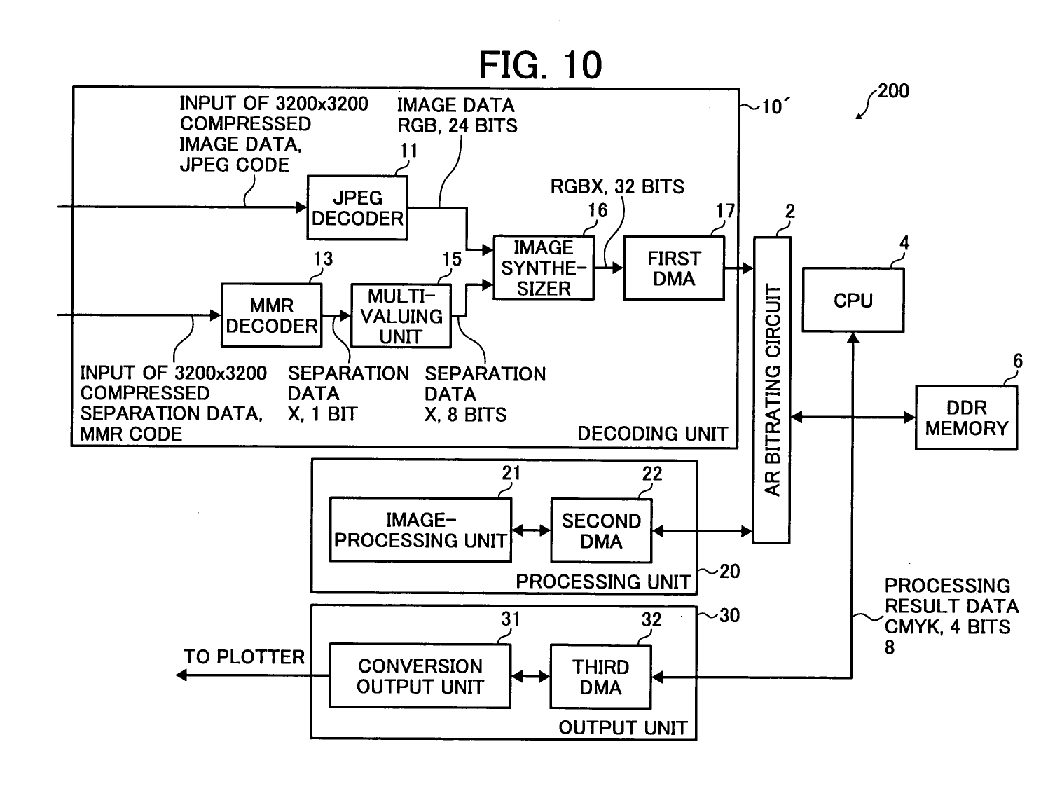

FIG. 10 is a functional block diagram of the image processor according to the second embodiment. An image processor 200 according to the second embodiment does not include the first SRAM 12 and the second SRAM 14 explained in the first embodiment.

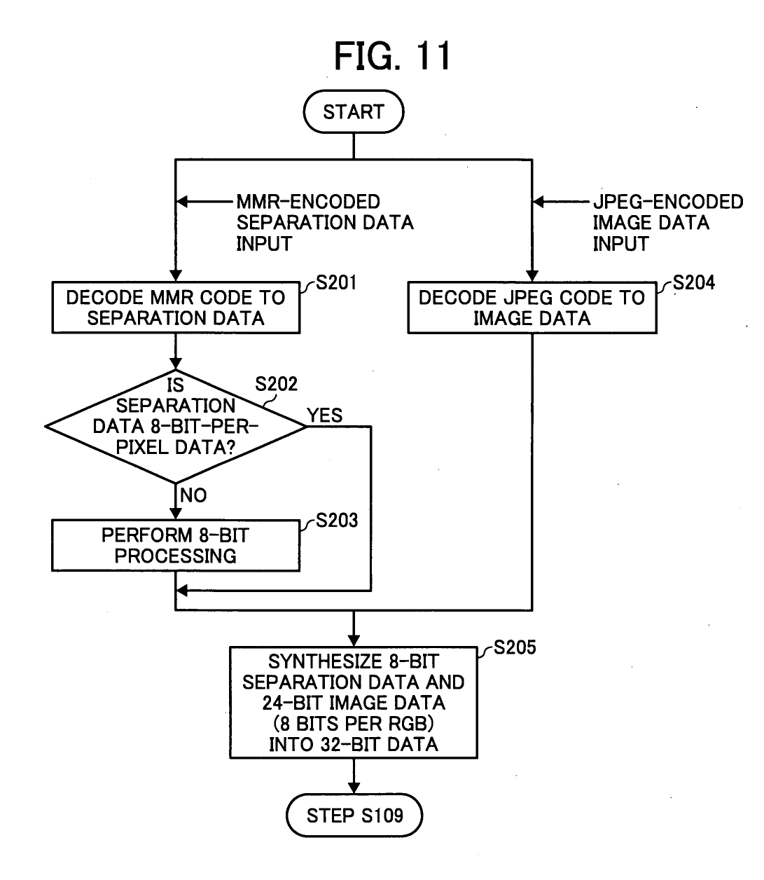

FIG. 11 is a flowchart of image processing according to the second embodiment. The MMR decoder 13 inputs the MMR-encoded separation data and performs MMR decoding (step S201). The multivaluing unit 15 determines whether the decoded separation data is 8-bit-per-pixel data (step S202). If the separation data is not 8-bit-per-pixel data (No at step S202), the multivaluing unit 15 performs multivalue processing to obtain 8-bit-per-pixel data (step S203).

The JPEG decoder 11 inputs the JPEG-encoded data and performs JPEG decoding (step S204). The image synthesizer 16 synchronously inputs the separation data subjected to 8-bit processing by the multivaluing unit 15 and the 24-bit image data subjected to decoding by the JPEG decoder 11, and synthesizes the image data and the separation data to 32-bit data (step S205). Because a subsequent process is similar to the process sequence after step S109 of the image processing according to the first embodiment, explanation thereof is omitted.

In the structure of the image processor 200 according to the second embodiment, without including the first SRAM 12 and the second SRAM 14, the decoded JPEG data and the decoded separation data are synchronously extracted, directly input to the image synthesizer 16, and the synthesis is performed. Due to this, frequent memory access can be omitted. Further, upon subsequent imaging processing on the data synthesized by the image synthesizer 16, the synthesized data is read only once based on the read separation data, and image processing is performed on the image data contained in the synthesized data. Thus, compared to the image processing in which the image data and the separation data are read from separate memories, memory access can be reduced and a high-speed image processing is enabled.

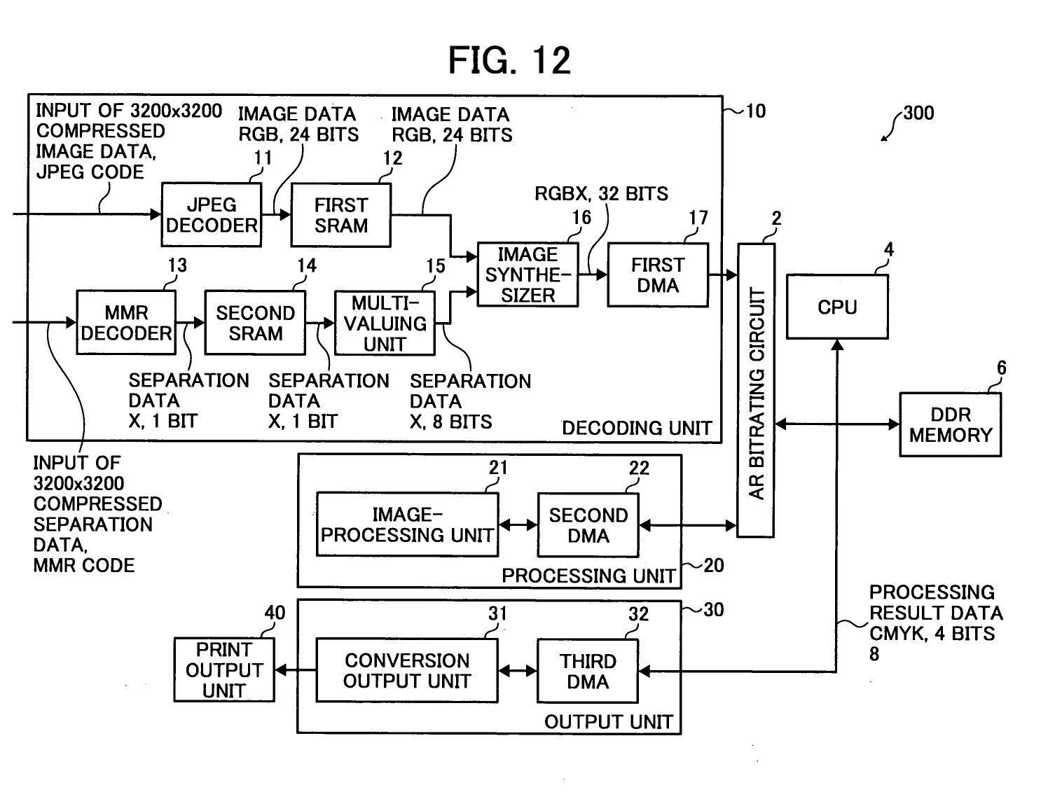

FIG. 12 is a functional block diagram of an image forming apparatus according to the third embodiment. An image forming apparatus 300 according to the third embodiment includes the image processor 100 according to the first embodiment and a printing unit 40.

According to conversion data generated by the conversion output unit 31, the printing unit 40 writes the image data to charged rotating bodies of CMYK using a laser beam, forms electrostatic latent images, transfers the electrostatic latent images to an intermediate transfer body using a latent image developing apparatus, and transfers the images to a recording paper. Because a technology related to printing is widely known, a detailed explanation is omitted.

Thus, similarly as explained in the first embodiment, in the image processor according to the third embodiment, the synthesized data of 32-bit length, which is a process unit of the image data, can be accessed and subjected to image processing. Due to this, a high-speed memory access and a high-speed image processing are enabled.

The separation data is represented by one bit of text or non-text. However, data in the form of a graphic image such as a text, a photograph, a graph etc. and a printed dot image, which enable to minutely distinguish characteristics of the image, can also be used as the separation data. Instead of one bit, the separation data can be set to any random number of bits such as two bits, three bits, four bits etc.

According to an embodiment of the present invention, compressed image data is decoded. Separation data, which indicates characteristics of an image, is received in a compressed format and decoded. For each pixel, the image data and the separation data decoded are subjected to synthesis such that a data length becomes an integral multiple of 32 bits. Due to this, synthesis can be performed that is appropriate for a commonly used 32-bit data processing. Further, an image processor can be provided that enables efficient and high-speed image processing even when carrying out 32-bit image processing.

According to another embodiment of the present invention, the separation data is decoded, the separation data in each pixel is subjected to multivalue processing such that a synthesis of the separation data and the image data becomes equal to the data length of an integral multiple of 32 bits. Due to this, synthesized data of 32-bit units can be generated without changing a bit count of the image data.

According to still another embodiment of the present invention, upon receiving the separation data that is one-dimensional losslessly compressed in block units, decoding is performed in the block units. Thus, the separation data can be decoded in the block units.

According to still another of the present invention, upon receiving the image data that is compressed in the block units mentioned earlier, decoding is performed and the decoded separation data and the image data are synthesized in the block units. Thus, synthesis can be performed on the image data and the separation data in the block units.

According to still another of the present invention, the image data subjected to decoding and the separation data subjected to decoding are stored, multivalue processing or synthesis is performed, and the stored image data and the multivalued separation data are synthesized and stored. Thus, execution of each process can be synchronized.

According to still another of the present invention, decoding is performed on the image data that is lossily compressed. Thus, the image data, which is highly compressed using lossy compression that is difficult to distinguish for a human eye, can be used.

According to still another of the present invention, decoding is performed on the separation data that is losslessly compressed. Thus, separation data having guaranteed accuracy due to lossless compression can be used as the separation data that requires accuracy as data.

According to still another of the present invention, synthesized image data is read and based on the separation data included in the synthesized image data, image processing is performed in pixel units on the image data that is included in the synthesized data. Due to this, one time reading of the synthesized image data enables image processing in the pixel units without a need to read the separation data from a memory. Thus, the image processor can be provided that enables a high-speed image processing with reduced memory access.

According to still another of the present invention, if the separation data subjected to decoding represents an image feature quantity that is a characteristic of the image in pixels, based on the image feature quantity, image processing is performed on the image data in each pixel. Thus, image processing is enabled that reflects the characteristic of the image in each pixel.

According to still another of the present invention, if the separation data subjected to decoding represents a text image, text emphasizing can be performed on the image data in each pixel. Thus, appropriate image processing is enabled.

According to still another of the present invention, based on the separation data subjected to decoding process, color conversion and binarization are performed on the image data in each pixel. Thus, according to the characteristic of the image in each pixel, appropriate color conversion and binarization can be performed.

According to still another of the present invention, decoding is performed on the separation data that is one-dimensional losslessly compressed in block units of 8 by 8 pixels. Decoding is performed on the image data that is compressed in block units of 8 by 8 pixels. The synthesis is performed on the separation data and the image data that are subjected to decoding in the block units of 8 by 8 pixels. Due to this, synthesizing in each pixel is easily timed. Further, using the block units of 8 by 8 pixels is especially appropriate for processing a JPEG monochromatic image.

According to still another of the present invention, decoding is performed on the separation data that is one-dimensional losslessly compressed in block units of 16 by 16 pixels. Decoding is performed on the image data that is compressed in the block units of 16 by 16 pixels. Synthesis is performed on the separation data and the image data that are subjected to decoding in the block units of 16 by 16 pixels. Due to this, synthesizing in each pixel is easily timed. Further, using the block units of 16 by 16 pixels is especially appropriate for processing a JPEG color image.

According to still another of the present invention, synthesis is performed on the image data that is subjected to decoding and the separation data that is subjected to decoding such that the data length of the synthesized image data in each pixel becomes equal to a process unit of 32 bits. Due to this, synthesis is enabled that is appropriate for data processing of commonly used 32-bit length. Further, the image processor can be provided that enables efficient and high-speed image processing.

According to still another of the present invention, synthesis can be performed by inputting the image data that is JPEG compressed and performing JPEG decoding.

According to still another of the present invention, synthesis can be performed by inputting the separation data that is MMR compressed and performing MMR decoding.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processor comprising:
a first decoding unit that decodes compressed image data;
a second decoding unit that receives separation data in a compressed format that indicates a characteristic of an image, and decodes the separation data; and
a synthesizing unit that synthesizes decoded image data and decoded separation data for each pixel into data with a length of an integral multiple of 32 bits.

2. The image processor according to claim 1, further comprising a multivalue processing unit that performs multivalue processing on the decoded separation data for each pixel to obtain data with a length of an integral multiple of 32 bits by synthesis, and outputs multivalued separation data to the synthesizing unit.

3. The image processor according to claim 1, wherein, upon receiving separation data that has been subjected to one-dimensional lossless compression in block units, the second decoding unit decodes the separation data in the block units.

4. The image processor according to claim 3, wherein
upon receiving image data that has been one-dimensionally compressed in block units identical to the block units, the first decoding unit decodes the image data in the block units, and
the synthesizing unit synthesizes decoded image data and decoded separation data in the block units.

5. The image processor according to claim 1, further comprising:
a first storage unit that stores therein the image data decoded by the first decoding unit and outputs the image data to the synthesizing unit;
a second storage unit that stores therein the separation data decoded by the second decoding unit and outputs the separation data to any one of the multivalue processing unit and the synthesizing unit; and
a third storage unit that stores therein synthesized data obtained by the synthesizing unit.

6. The image processor according to claim 1, wherein the first decoding unit decodes image data that has been subjected to lossy compression.

7. The image processor according to claim 1, wherein the second decoding unit decodes separation data that has been subjected to lossless compression.

8. The image processor according to claim 1, further comprising an image-processing unit that reads synthesized data obtained by the synthesizing unit, and, based on the separation data contained in the synthesized data, processes the image data contained in the synthesized data in pixel units.

9. The image processor according to claim 8, wherein
the decoded separation data represents an image feature quantity as the characteristic of the image in pixels corresponding to the separation data, and
the image-processing unit processes the image data for each pixel based on the image feature quantity.

10. The image processor according to claim 8, wherein, when the separation data indicates that the corresponding pixels represent a text image, the image-processing unit performs text emphasizing process on the image data for each of the pixels.

11. The image processor according to claim 8, wherein the image-processing unit performs, based on the separation data, color conversion and binarization of the image data for each pixel.

12. The image processor according to claim 1, wherein
upon receiving separation data that has been subjected to one-dimensional lossless compression in block units of 8 by 8 pixels, the second decoding unit decodes the separation data,
upon receiving image data that has been compressed in block units of 8 by 8 pixels, the first decoding unit decodes the image data, and
the synthesizing unit synthesizes the image data and the separation data decoded in the block units of 8 by 8 pixels.

13. The image processor according to claim 1, wherein
upon receiving separation data that has been subjected to one-dimensional lossless compression in block units of 16 by 16 pixels, the second decoding unit decodes the separation data,
upon receiving image data that has been compressed in block units of 16 by 16 pixels, the first decoding unit decodes the image data, and
the synthesizing unit synthesizes the image data and the separation data decoded in the block units of 16 by 16 pixels.

14. The image processor according to claim 1, wherein the synthesizing unit synthesizes the decoded image data and the decoded separation data for each pixel into data with a length of 32 bits.

15. The image processor according to claim 1, wherein, upon receiving image data that has been subjected to Joint Photographic Experts Group (JPEG) compression, the first decoding unit perform JPEG decoding of the image data.

16. The image processor according to claim 1, wherein, upon receiving separation data that has been subjected to Modified Modified Read (MMR) compression, the second decoding unit performs MMR decoding of the separation data.

17. An image processing method that is applied to an image processor, the image processing method comprising:
first-decoding compressed image data;
receiving separation data in a compressed format that indicates a characteristic of an image;
second-decoding the separation data; and
synthesizing decoded image data and decoded separation data for each pixel into data with a length of an integral multiple of 32 bits.

18. The image processing method according to claim 17, further comprising:
performing multivalue processing on the decoded separation data for each pixel to obtain data with a length of an integral multiple of 32 bits at the synthesizing; and
outputting multivalued separation data.

19. The image processing method according to claim 17, wherein, on receipt of separation data that has been subjected to one-dimensional lossless compression in block units, the second-decoding includes decoding the separation data in the block units.

20. The image processing method according to claim 19, wherein
on receipt of image data that has been one-dimensionally compressed in block units identical to the block units, the first-decoding includes decoding the image data in the block units, and
the synthesizing includes synthesizing decoded image data and decoded separation data in the block units.
